(19) United States
(12) Patent Application Publication
(10) Pub. No.: US 2015/0130792 A1
(43) Pub. Date: May 14, 2015

(54) INTEGRATION OF LABELS INTO A 3D GEOSPATIAL MODEL

(71) Applicant: Microsoft Corporation, Redmond, WA (US)

(72) Inventors: Isaac Kenneth Kunen, Seattle, WA (US); Romualdo Impas, Seattle, WA (US); Donald A. Barnett, Monroe, WA (US); Juan Pablo Candelas Gonzalez, Woodinville, WA (US); Brenton Gunning, Seattle, WA (US); David Buerer, Woodinville, WA (US)

(73) Assignee: Microsoft Corporation, Redmond, WA (US)

(21) Appl. No.: 14/252,414

(22) Filed: Apr. 14, 2014

Related U.S. Application Data
(60) Provisional application No. 61/904,441, filed on Nov. 14, 2013.

(51) Int. Cl. G06T 19/20; G06T 15/00

(52) U.S. Cl. CPC G06T 19/20; G06T 15/005; G06T 2219/2008; G06T 2219/2016; G06T 2210/61
USPC 345/419

(57) ABSTRACT

Architecture that enables the representation of labels as objects in the 3D (three-dimensional) world, with size, elevation, and orientation. Logical hierarchies in the world are represented by the placement and prominence of labels in the 3D world scene. For example, state labels are positioned higher and larger than city labels. The illusion of the label as a fixed element in the 3D model is maintained during manipulations. Additionally, movement is provided to ensure legibility, but is delayed until the user's input is quiescent. Moreover, labels along roads, for example, can be oriented to stand vertically along a curve.

### CROSS-REFERENCE TO RELATED APPLICATIONS

This application claims the benefit of U.S. Provisional Patent application Ser. No. 61/904,441 entitled “INTEGRATION OF LABELS INTO A 3D GEOSPATIAL MODEL” and filed Nov. 14, 2013, the entirety of which is incorporated by reference herein. This application is related to pending patent application Ser. No. 14/210,343, entitled “MAINTAINING 3D LABELS AS STABLE OBJECTS IN 3D WORLD”, filed Mar. 13, 2014.

### BACKGROUND

Integrating labels into a 3D (three-dimensional) representation of the world presents problems not present in 2D (two-dimensional) representations. The view of a 2D map is typically very constrained, making the integration of 2D labels into that model relatively straightforward. However, in a 3D model, several new problems become apparent. Labels, which can be 2D blocks of text, present integration problems into a 3D model at least insofar as the label is presented as an integrated part of the experience. Additionally, once the 3D illusion might initially attained maintaining the 3D model as the model (e.g., a map) is manipulated in three dimensions introduces additional problems. Still further, while labels are intended to be read, there is a need for readability that should be balanced against the desire to have a coherent, synthetic 3D experience. Moreover, natural hierarchies (e.g., country, state, county, city, etc.) can be problematic as to representation in the 3D geospatial model.

Existing solutions involve applying 2D tiles to a globe, thereby simply projecting the 2D map onto the globe surface; however, this technique is simply a 2D map projected onto the surface of a 3D model, with labels effectively painted on the ground. These systems do not give a true 3D illusion to the users, and have significant impediments to legibility, since labels can be oriented improperly and highly obliquely relative to the user's view. Another technique effectively paint 2D labels on a screen-facing plane. While the label legibility may be adequate, the labels are not truly integrated into the 3D model, and seem to “float” unnaturally in front of the background model. Existing systems imply do not truly represent hierarchy or present the illusion of an integrated 3D model.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables the representation of labels as objects in the 3D (three-dimensional) world, with size, elevation, and orientation. Logical hierarchies in the world are represented by the placement and prominence of labels in the 3D world scene. For example, state labels are positioned higher and larger than city labels. The illusion of the label as a fixed element in the 3D model is maintained during manipulations. Additionally, movement is provided to ensure legibility, but is delayed until the user's input is quiescent. Moreover, labels along roads, for example, can be oriented to stand vertically along a curve.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates views that depict a label in a map as a 3D object with size, elevation, and orientation.

FIG. 3 illustrates an oblique view of the map of FIG. 2.

FIG. 4 illustrates label object hierarchy in a view.

FIG. 5 illustrates a view of label adjustment in response to zoom-in.

FIG. 6 illustrates a more detailed view as the user continues to zoom-in on a state.

FIG. 7 illustrates a more detailed view as the user continues to zoom-in further on a large city such as Denver.

FIG. 8 illustrates a series of views that show label re-orientation.

FIG. 9 illustrates an oblique low-elevation view of a neighborhood showing label object manipulation.

FIG. 10 illustrates a method in accordance with the disclosed architecture.

FIG. 11 illustrates an alternative method in accordance with the disclosed architecture.

FIG. 12 illustrates a block diagram of a computing system that executes label integration and manipulation in a 3D geospatial model in accordance with the disclosed architecture.

### DETAILED DESCRIPTION

The disclosed architecture enables the representation of labels as objects in the 3D (three-dimensional) world, with size, elevation, and orientation. Logical hierarchies in the world are represented by the placement and prominence of labels in the 3D world scene. For example, state labels are positioned higher and larger than city labels. The illusion of the label as a fixed element in the 3D model is maintained during manipulations. Additionally, movement is provided to ensure legibility, but is delayed until the user's input is quiescent. Moreover, labels along roads, for example, can be oriented to stand vertically along a curve.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

In the following Figures, some scenes are presented in symbolic (map) mode and other scenes can be shown in photorealistic (or aerial) mode. In other words, the disclosed architecture applies equally to both modes. In accordance with the disclosed architecture, labels can be represented as objects in the 3D world (scene), with size, elevation, and/or orientation. This means that rather than being modeled as objects in the screen plane, the labels are represented in the 3D model and projected into the view plane along with the rest of the scene and scene objects (“world”).

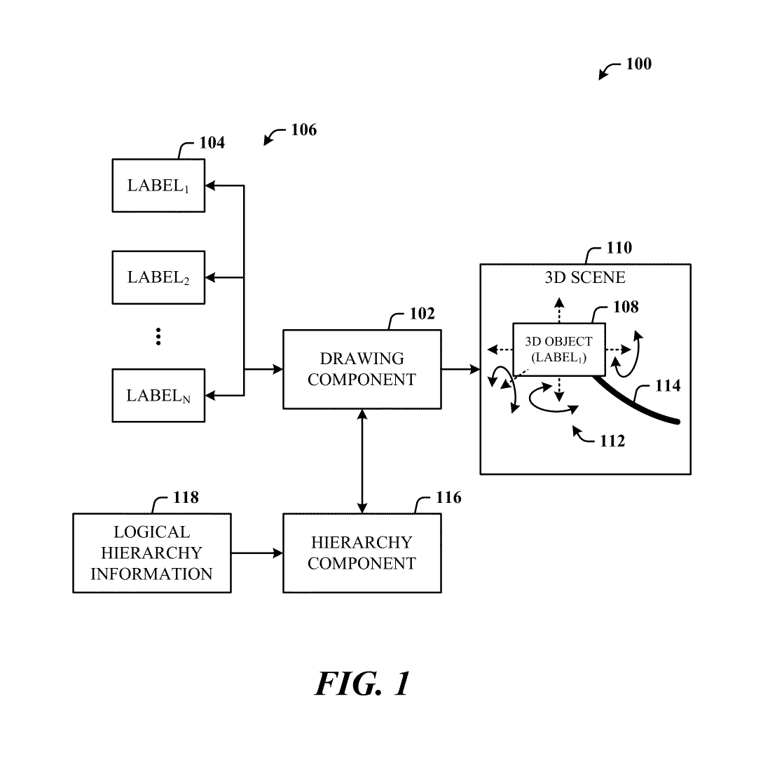

FIG. 1 illustrates a system 100 in accordance with the disclosed architecture. The system 100 comprises a drawing component 102 configured to draw a label 104 (of labels 106) as a 3D (three-dimensional) label object 108 in a 3D scene 110 and according to a label orientation 112. The label orientation 112 can be along at least three axes, as shown by the dotted arrows. Additionally, the label object 108 can be bent to follow a contour of a 3D scene object 114 to which the label object 108 is associated. Each of the labels 106 drawn in the 3D scene can be rendered with a different orientation, and optionally, a flex (or bend); however, it is to be understood that the orientation is to be suitable for a viewer to read or understand when looking at the 3D label object 108 in the 3D scene 110. The drawing component 102 is can be suitably programmed to operate as a separate application than device and/or server rendering software; however, this need not be so limiting, since the drawing component 102 can alternatively be programmed as part of the rendering software.

A hierarchy component 116 of the system 100 can be configured to input logical hierarchical information 118 to the drawing component 102 to draw the labels 106 in the 3D scene 110 according to a logical hierarchy. For example, the logical hierarchy defined by the logical hierarchical information 118 can include drawing label size based on geographical areas, demographic areas, political areas, etc. For example, a label for the name of a state is drawn larger and at a higher elevation than the name of a state county, which is drawn larger and at a higher elevation than the name of a city in the county, and so on. The logical hierarchical information 118 can be obtained from sources such as geographical websites, city websites, etc., that typically store this information and maintain the information in an updated state.

The logical hierarchical information 118 indicates label size of the label object relative to other label objects. The label object 108 can be drawn to follow a contour of an associated scene object 114 identified with the label object. The label orientation of the label object 108 is maintained in response to manipulation of the 3D scene 110. The label object 108 is drawn as oriented vertically on a line (e.g., route) of a map. The label object 108 is re-oriented to a new readable orientation in response to a predetermined delay following a manipulation of the scene 110. The labels are projected in a view plane of the 3D scene. The 3D label objects are drawn in the 3D scene 110 based on properties of at least size, elevation, and orientation. Other attributes or graphical emphasis can be employed such as coloration, fonts, and so on.

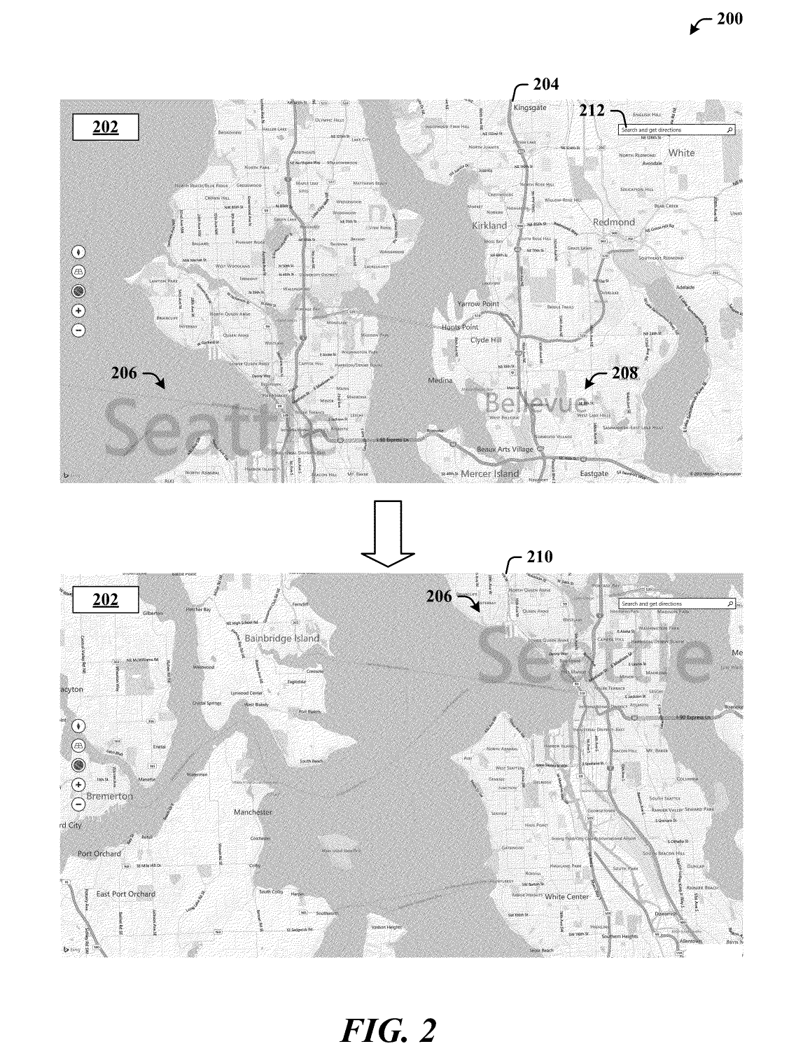

FIG. 2 illustrates views 200 that depict a label in a 202 map as a 3D object with size, elevation, and orientation. In a first view 204 of the map 202, a “Seattle” label 206 has differentiating size (from “Bellevue” label 208) and (upright and horizontal) orientation in the 3D model of the map 202, as well as elevation (the “Seattle” label 206 higher in elevation than the “Bellevue” label 208).

In a second view 210, the label elevation property becomes apparent when the map 202 is moved (the scene is changed). Here, the map 202 is dragged and moved in an approximate forty-five degree direction (up and to the right). The “Seattle” label 206 moves relative to the ground in the projection, but is fixed in the world model, thereby proving a parallax effect. A search box 212 can also be presented for user interaction to obtain information about a map entity as well as directions.

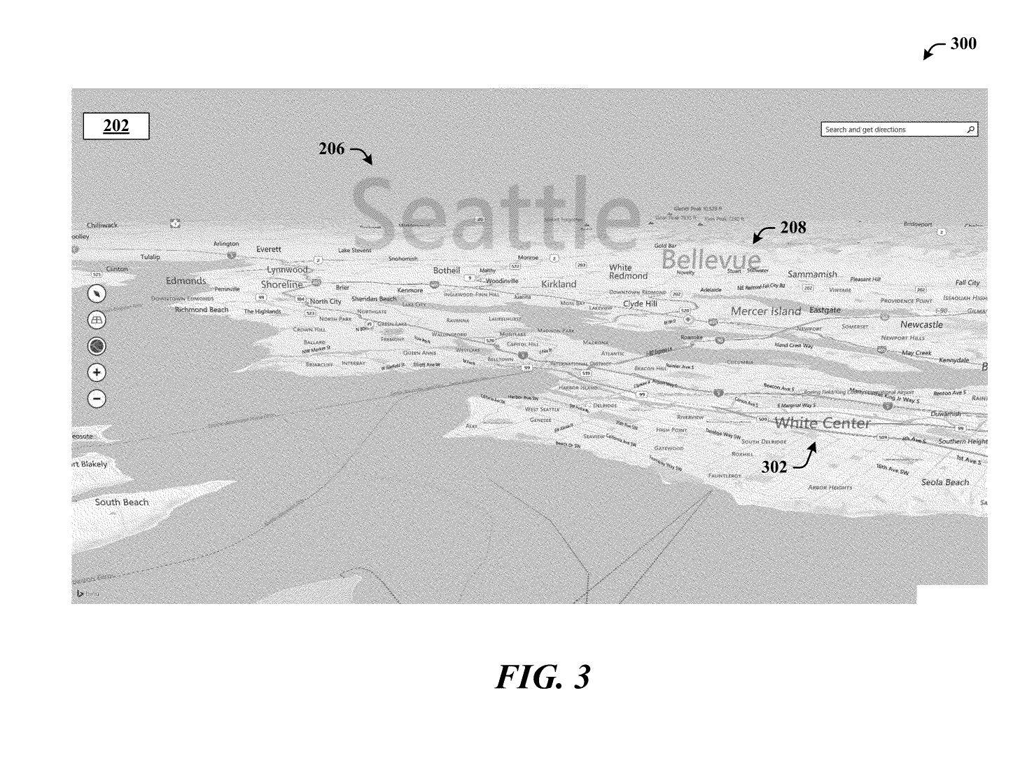

FIG. 3 illustrates an oblique view 300 of the map 202 of FIG. 2. In this oblique view 300, the parallax effect between the labels (e.g., the “Seattle” label 206 and the “Bellevue” label 208) and the ground shows the visual results from label elevation. Street/avenue level labels can be aligned with the corresponding street/avenue, and presented as having elevation that is “on the ground”, relative to a larger area such as a “White Center” label 302, which is higher in elevation than a street/avenue label but lower in elevation than the “Bellevue” label 208. The “Seattle” label 206 is presented larger and higher in elevation than the “Bellevue” label 208 for any number of reasons. For example, the entity Seattle is closer geographically to the user in the oblique view 300 and the entity Bellevue is more distant geographically from the user. Alternatively, or in combination therewith, the font of the “Seattle” label 206 can be representative of population or land mass of Seattle (larger than Bellevue) relative to the Bellevue entity.

It can be the case that the architecture enables the user/viewer to select different properties to observe in the oblique view 300 (or any view depicted herein) such as population, land mass, businesses, entertainment spots, churches, etc., in response to which the labels are drawn to represent these properties.

The architecture also enables the user/viewer to zoom-in and zoom-out on different parts of the map 202 (similar to the scene 110). The label size can also be generally maintained during the zoom operation (in and out). Additionally, the label can also be scaled up more rapidly than the terrain as the user gets really close to (just before moving past) the label. This allows the more real illusion of the label as a fixed element, including making the “flying through” experience more believable as the user/viewer zooms in/out on the map.

The “Seattle” label 206 and “Bellevue” label 208 have been reoriented to stand upright in 3D space, and clearly have elevation, hovering above their respective regions (map objects or “entities”). Note also that street labels stand upright and align along the streets in the 3D model.

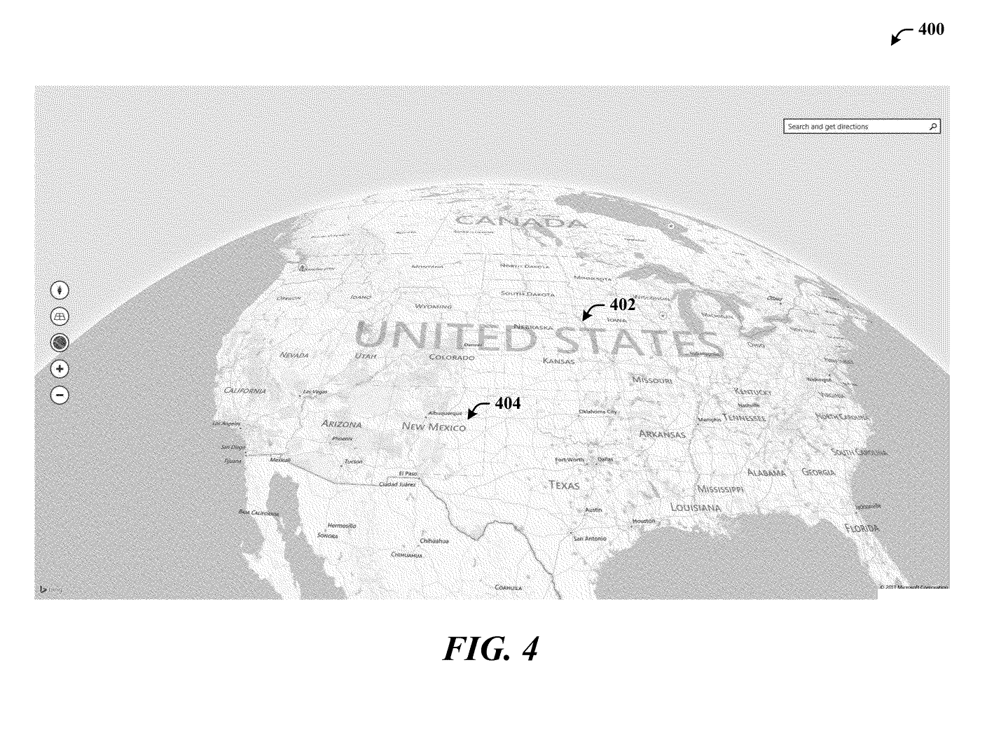

FIG. 4 illustrates hierarchy in a view 400. People naturally organize things into logical hierarchies. Accordingly, logical hierarchies are represented by placing objects that are higher in the hierarchy, at a higher elevation in the physical 3D model, and by giving objects that are higher in the hierarchy a larger font size than objects lower in the hierarchy (e.g., at a country-level, the “UNITED STATES” label 402 floats higher and fainter above the state labels such as a “New Mexico” label 404). Moreover, in one implementation, notice that the labels (e.g., the “UNITED STATES” label 402 and the “New Mexico” label 404) are presented as laid down and conforming to the curvature of the Earth. In an alternative implementation, the labels (e.g., the “UNITED STATES” label 402 and the “New Mexico” label 404) are presented as flat (parallel to the ground plane).

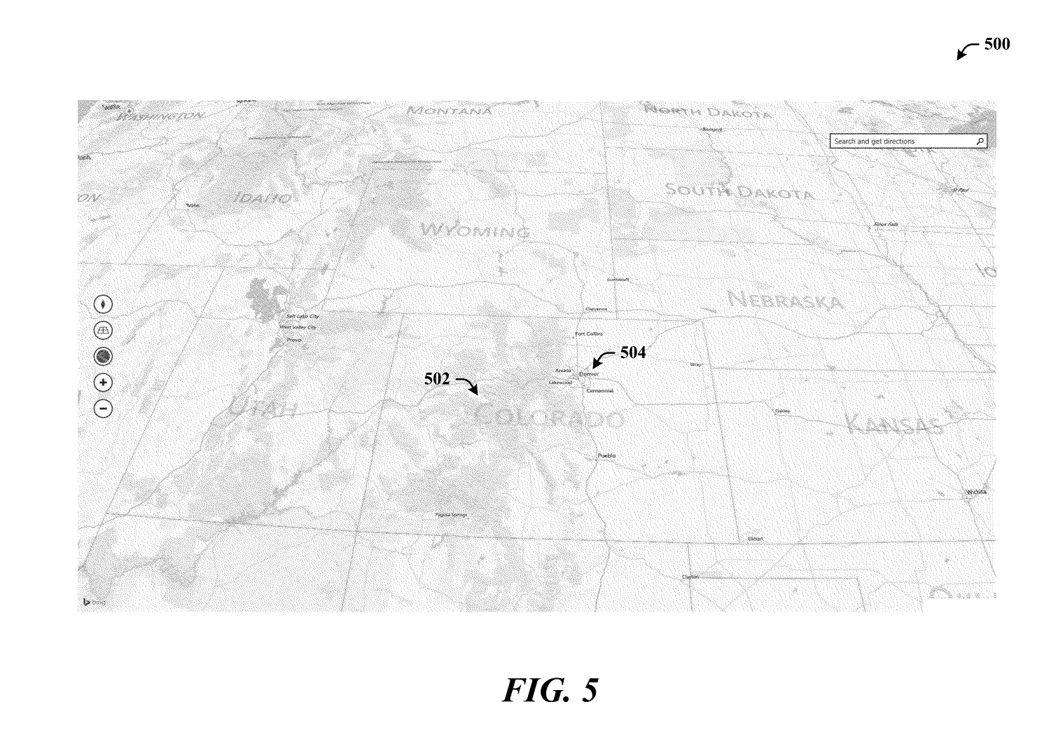

FIG. 5 illustrates a view 500 of label adjustment in response to zoom-in. In general, higher elevated labels in the visual hierarchy are scaled up more rapidly and faded out, as the user “flies in” closer (reduces elevation) to the terrain. This provides the illusion of ‘flying through’ the labels as the user/viewer gets really close to, and past, those labels. For example, as the user “flies in” closer (reduces elevation) to the terrain, the country label (“UNITED STATES” label 402 of the previous FIG. 4) is removed, now showing state labels (e.g., a “Colorado” label 502) floating above larger cities (as represented by larger-city labels such as a “Denver” label 504).

Alternatively, the presentation can be such that the user perceives moving through the space allocated for the “UNITED STATES” label 402 (of the FIG. 4) after the label 402 is faded out prior to reaching the label space. As shown before, the label higher in elevation has the larger font and fainter label name definition than the lower elevation labels. This approach enables the presentation of information on the area the user is viewing without unduly interfering with the underlying detail in which the user may be interested.

Additionally, this approach can be employed as a means to compute an inference that since the user is zooming-in, the user intends or shows more interest in the underlying (or lower in elevation) objects and less interest in the overlying (or higher in elevation) objects. Still further, maintaining the visual hierarchy in the world view is enabled and beneficial to the viewer. Thus, based on this inference, the architecture adjusts label characteristics accordingly.

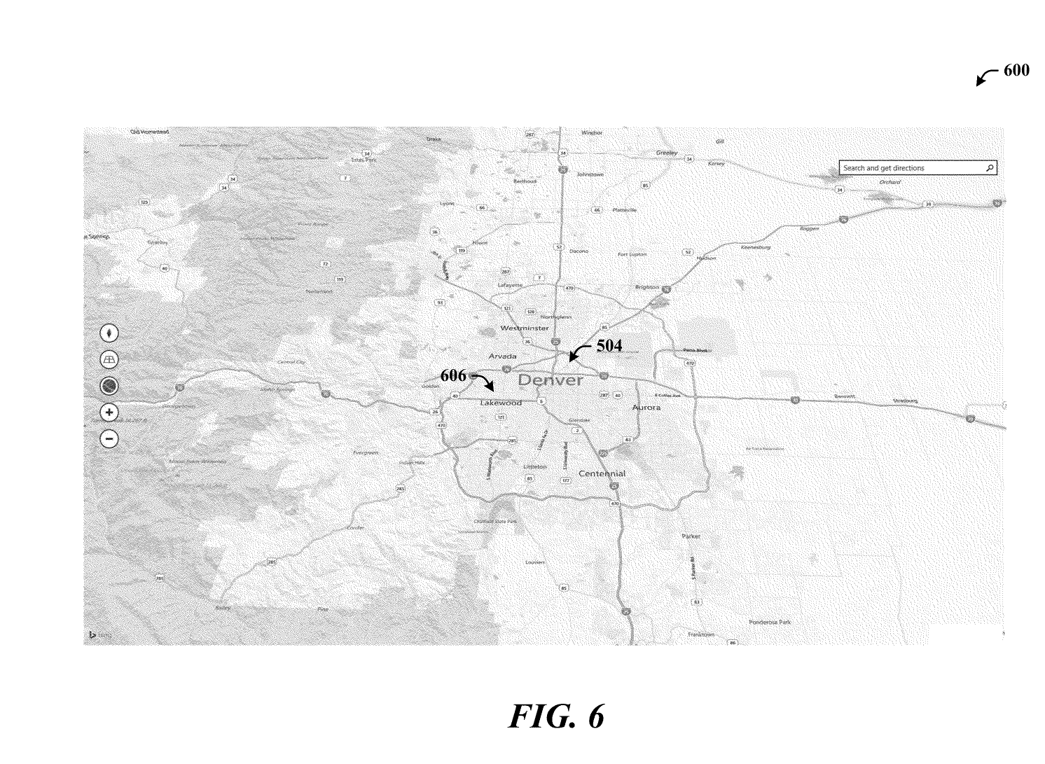

Continuing with the fly-in example above, FIG. 6 illustrates a more detailed view 600 as the user continues to zoom-in on a state. The state labels for the state of interest (e.g., Colorado) and surrounding states are removed from view, and the labels for larger cities in Colorado, for example, such as Denver label 504, float above the Denver suburbs (e.g., a “Lakewood” label 606).

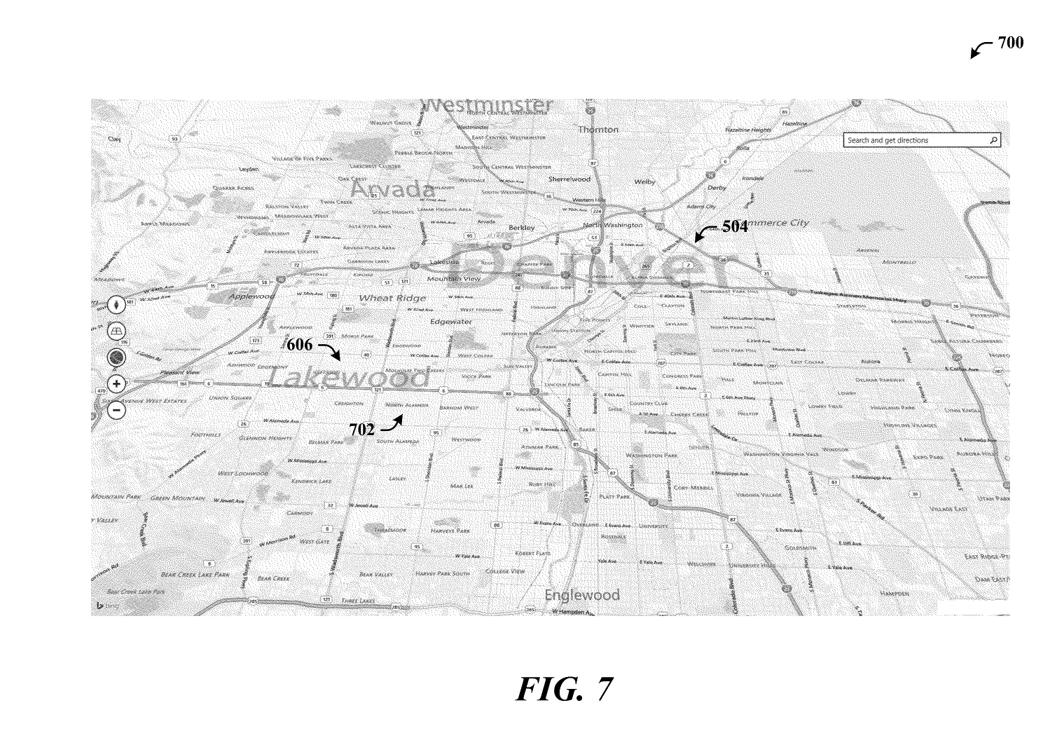

Continuing with the fly-in example above, FIG. 7 illustrates a more detailed view 700 as the user continues to zoom-in further on a large city such as Denver. Closer still, the neighborhood labels appear (e.g., a neighborhood “North Alameda” label 702), still smaller in font and lower in elevation than their containing cities (e.g., Lakewood, for the North Alameda neighborhood).

In existing systems, hierarchy is not represented using size or altitude of the labels, and as the user navigates the world, for example, keeping labels fixed in the 3D space yields labels that are illegible because the labels are backwards or seen too obliquely. On the other hand, maintaining the labels in the 3D model reinforces the illusion of a synthetic whole to the user. The disclosed architecture maintains the illusion of the label as a fixed element in the 3D model during manipulations, including manipulations that pan, tilt, or change camera heading. Movement to ensure legibility (readability) is provided, but can be delayed until the user input is quiescent, at which time, labels animate to reorient and stand up or lie down.

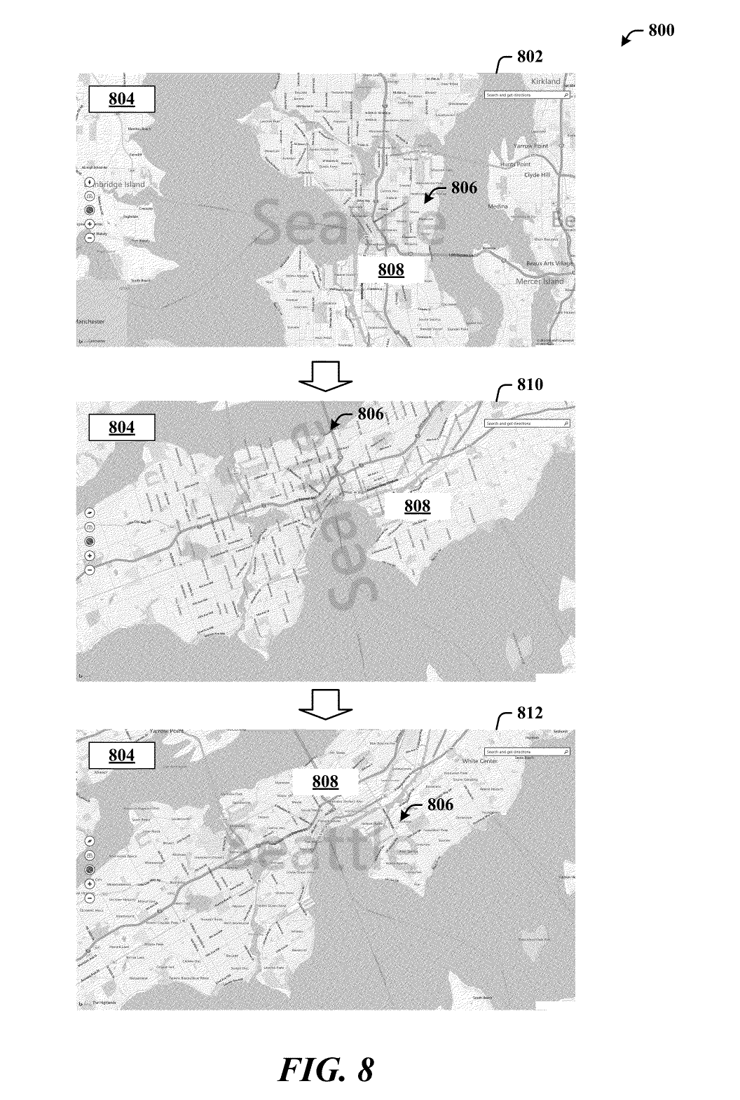

FIG. 8 illustrates a series of views 800 that show label re-orientation. In a first view 802, a map 804 is presented with a “Seattle” label object 806 associated with an underlying Seattle map object 808. In a second view 810, the user has rotated the map 804 (e.g., counterclockwise) such that the underlying Seattle map object 808 and associated “Seattle” label object 806 have rotated as well in accordance with the amount of map rotation. Thus, the “Seattle” label object 806 is oriented as substantially sideways, as shown, as well as other labels in the second view 810. In a third view 812, after some trigger event (e.g., elapsed time, direct user action, etc.), the “Seattle” label object 806 (and all other labels) is re-oriented to an upright orientation for easier readability by the user.

It can be an alternative case, that as the user rotates the map 804, the labels are maintained in an upright orientation until the map rotation is completed. Thereafter, the label 3D position is adjusted on the map 804, since the orientation has already been maintained. In yet another implementation, when the user initiates a rotation action, the labels are removed entirely from view, and when rotation has completed, the newly-oriented and positioned labels are presented back into the view. In still another embodiment, when the user initiates rotation, only the higher level labels are shown at elevation and re-oriented concurrently with the rotation (or accordingly to delayed re-orientation and positioning), and when rotation is deemed to have been completed, all lower-level labels are popped (rendered) back into the view as re-oriented and re-positioned.

These animation techniques can be applied to many different user actions, and also made user-configurable as a user preference for interacting with 3D labels in a geospatial model.

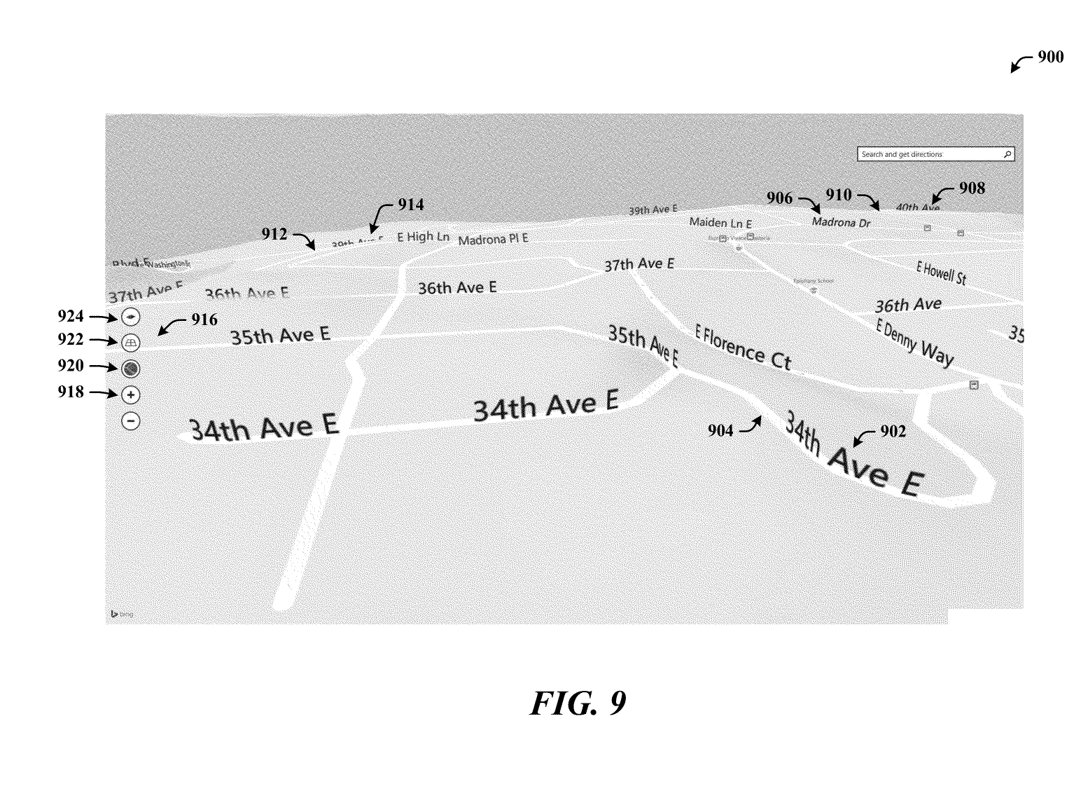

FIG. 9 illustrates an oblique low-elevation view 900 of a neighborhood showing label object manipulation. One particular type of 3D label placement technique aligns labels along routes and then orients the labels to stand vertically along the route and around curves. For example, a “34^{th} Ave E” label 902 is rendered as following a curve in the associated route 904.

Additionally, the labels have perspective such that closer labels are larger in font and more distant labels are smaller in font. For example, a closer label, the “34^{th} Ave E” label 902 is larger than a more distant “Madrona Dr” label 906.

Still further, a route that partially disappears over a hill (or the horizon) has an associated label that is also partially and appropriately obscured (occluded) to indicate the route goes over the horizon. For example, a “40^{th} Ave” label 908 is partially obscured to follow the associated route 910 as disappearing over the horizon. Similarly, a route that partially disappears into a valley of the visible terrain has an associated label that is also partially and appropriately obscured (occluded) to indicate the route goes into a valley. For example, a route 912 runs through a valley (or geographical depression); accordingly, the associated label, “39^{th} Ave E” label 914, is partially obscured and exhibits curvature to follow the route 912 to infer that the associated route 912 runs through the valley. This applies as well to route that run over or around hills, etc.

As shown with previous views, the user is presented with a toolset 916 that enables the user to manipulate the view 900. For example, zoom tools 918 (e.g., ⊕ and ⊖), a map tool 920, a perspective tool 922, and elevation tool 924.

In an alternative embodiment, the user may be provided the capability to move under higher hierarchical level, and even higher elevation level, labels when looking upward (e.g., skyward) to tall structures (e.g., buildings, mountains), cloud formations, objects presented as at higher elevations (e.g., satellites, flying objects, etc.), and so on. Additionally, the labels are presented according to a suitable orientation and position for the user view.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

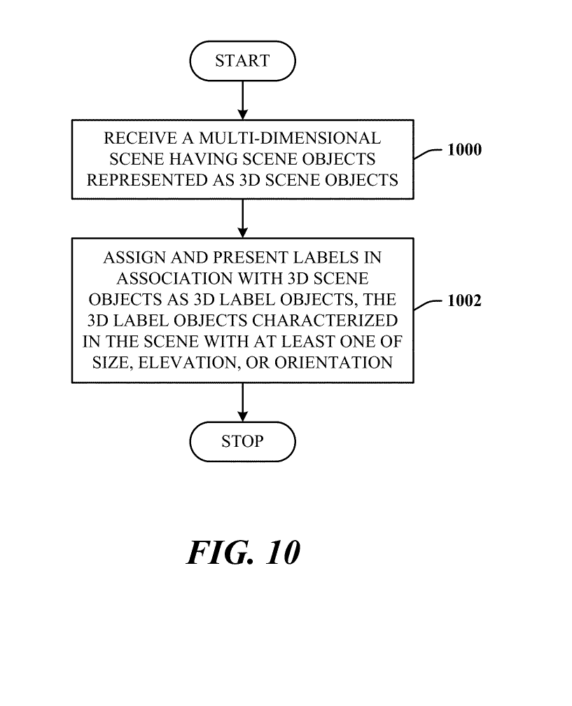

FIG. 10 illustrates a method in accordance with the disclosed architecture. At 1000, a multi-dimensional scene is received as having scene objects represented as 3D scene objects. At 1002, labels are assigned and presented in association with the 3D scene objects in the scene as 3D label objects. The label objects are characterized in the scene with at least one of size, elevation, or orientation properties.

The method can further comprise representing size of a 3D label object as different from another label size according to a label hierarchy. The method can further comprise drawing a 3D label object in alignment with a contour in the scene, which is a 3D scene. The method can further comprise maintaining orientation of a 3D label object in response to a change of the scene. The method can further comprise projecting the labels in a view plane of the scene.

The method can further comprise representing the 3D labels according to graphical emphasis that indicates a logical hierarchy. The method can further comprise, in response to a zoom-in operation of the scene from a given elevation and elevated 3D label object, phasing out the elevated 3D label object from view and drawing a new 3D label object associated with a lower elevation.

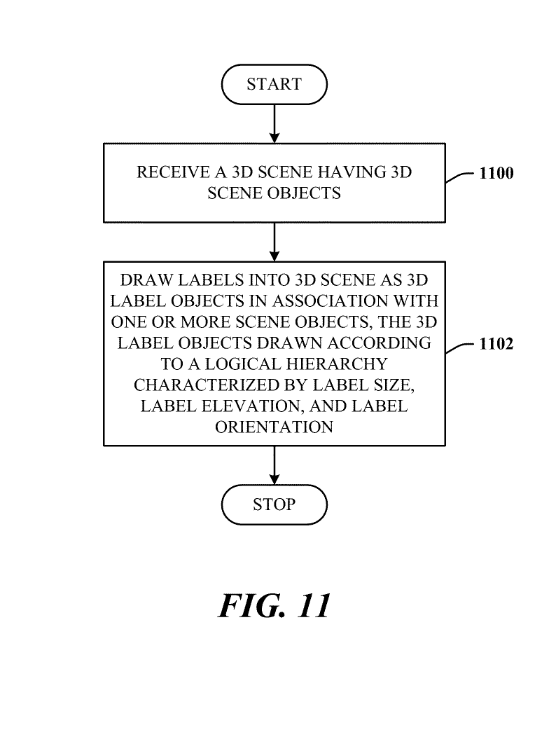

FIG. 11 illustrates an alternative method in accordance with the disclosed architecture. The method can be embodied in a computer-readable storage medium comprising computer-executable instructions that when executed by a hardware processor, cause the processor to perform the following acts. At 1100, a 3D scene having 3D scene objects, is received. At 1102, labels are drawn into 3D scene as 3D label objects in association with one or more scene objects. The 3D label objects are drawn according to a logical hierarchy characterized by label size, label elevation, and label orientation.

The method can further comprise representing size of a 3D label relative to distance of the 3D label object from a virtual camera. The method can further comprise drawing a 3D label object in alignment with a contour in the 3D scene and in a readable orientation to a virtual camera from which the 3D scene is viewed.

The computer-readable storage medium of claim 16, further comprising re-orienting the 3D label objects to an orientation that ranges between a vertical orientation and a horizontal orientation, the 3D label objects re-oriented according to a stepped movement and relative to an acquiescence state. The computer-readable storage medium of claim 16, further comprising drawing 3D label objects in association with curved 3D scene objects and with curvature that corresponds to curvature of the curved 3D scene objects.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

Moreover, it is to be understood that in the disclosed architecture, certain components may be rearranged, combined, omitted, and additional components may be included. Additionally, in some embodiments, all or some of the components are present on the client, while in other embodiments some components may reside on a server or are provided by a local or remove service.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

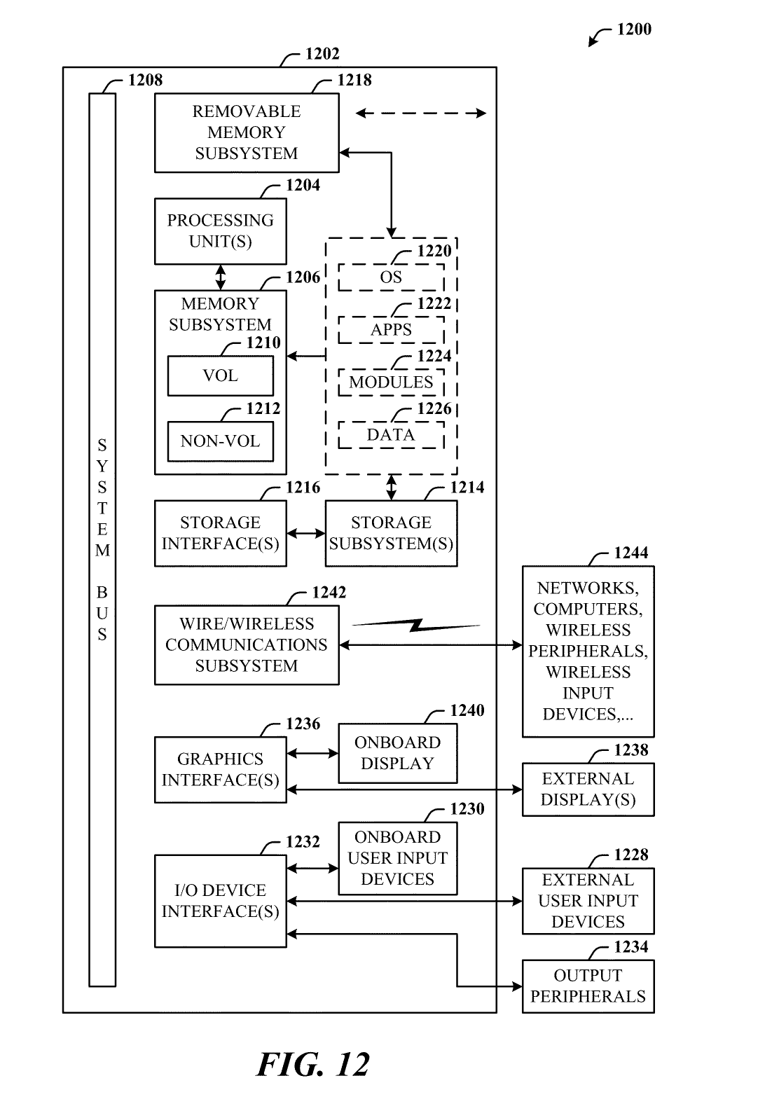

Referring now to FIG. 12, there is illustrated a block diagram of a computing system 1200 that executes label integration and manipulation in a 3D geospatial model in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 12 and the following description are intended to provide a brief, general description of the suitable computing system 1200 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1200 for implementing various aspects includes the computer 1202 having microprocessing unit(s) 1204 (also referred to as microprocessor(s) and processor(s)), a computer-readable storage medium such as a system memory 1206 (computer readable storage medium/media also include magnetic disks, optical disks, solid state drives, external memory systems, and flash memory drives), and a system bus 1208. The microprocessing unit(s) 1204 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 1202 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 1206 can include computer-readable storage (physical storage) medium such as a volatile (VOL) memory 1210 (e.g., random access memory (RAM)) and a non-volatile memory (NON-VOL) 1212 (e.g., ROM, EPROM, EEPROM, etc.). A basic input/output system (BIOS) can be stored in the non-volatile memory 1212, and includes the basic routines that facilitate the communication of data and signals between components within the computer 1202, such as during startup. The volatile memory 1210 can also include a high-speed RAM such as static RAM for caching data.

The system bus 1208 provides an interface for system components including, but not limited to, the system memory 1206 to the microprocessing unit(s) 1204. The system bus 1208 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1202 further includes machine readable storage subsystem(s) 1214 and storage interface(s) 1216 for interfacing the storage subsystem(s) 1214 to the system bus 1208 and other desired computer components and circuits. The storage subsystem(s) 1214 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 1216 can include interface technologies such as EIDE, ATA, SATA, and IEEE 1394, for example.

One or more programs and data can be stored in the memory subsystem 1206, a machine readable and removable memory subsystem 1218 (e.g., flash drive form factor technology), and/or the storage subsystem(s) 1214 (e.g., optical, magnetic, solid state), including an operating system 1220, one or more application programs 1222, other program modules 1224, and program data 1226.

Generally, programs include routines, methods, data structures, other software components, etc., that perform particular tasks, functions, or implement particular abstract data types. All or portions of the operating system 1220, applications 1222, modules 1224, and/or data 1226 can also be cached in memory such as the volatile memory 1210 and/or non-volatile memory, for example. It is to be appreciated that the disclosed architecture can be implemented with various commercially available operating systems or combinations of operating systems (e.g., as virtual machines).

The storage subsystem(s) 1214 and memory subsystems (1206 and 1218) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 1202, and include volatile and non-volatile internal and/or external media that is removable and/or non-removable. For the computer 1202, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 1202, programs, and data using external user input devices 1228 such as a keyboard and a mouse, as well as by voice commands facilitated by speech recognition. Other external user input devices 1228 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 1202, programs, and data using onboard user input devices 1230 such a touchpad, microphone, keyboard, etc., where the computer 1202 is a portable computer, for example.

These and other input devices are connected to the microprocessing unit(s) 1204 through input/output (I/O) device interface(s) 1232 via the system bus 1208, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1232 also facilitate the use of output peripherals 1234 such as printers, audio devices, camera devices, and so on, such as a sound card and/or onboard audio processing capability.

One or more graphics interface(s) 1236 (also commonly referred to as a graphics processing unit (GPU)) provide graphics and video signals between the computer 1202 and external display(s) 1238 (e.g., LCD, plasma) and/or onboard displays 1240 (e.g., for portable computer). The graphics interface(s) 1236 can also be manufactured as part of the computer system board.

The operating system 1220, one or more application programs 1222, other program modules 1224, and/or program data 1226, and/or graphics interfaces 1236 can include enable label integration, manipulation, animation, and rendering to provide the capabilities shown in system 100 of FIG. 1, the view 200 of FIG. 2, shown in the view 300 of FIG. 3, shown in the hierarchical view 400 of FIG. 4, shown in the view 500 of FIG. 5, shown in the view 600 of FIG. 6, shown in the view 700 of FIG. 7, shown in the views 800 of FIG. 8, and shown in the view 900 of FIG. 9, and the methods represented by the flowcharts of FIGS. 10 and 11, for example.

The computer 1202 can operate in a networked environment (e.g., IP-based) using logical connections via a wired/wireless communications subsystem 1242 to one or more networks and/or other computers. The other computers can include workstations, servers, routers, personal computers, microprocessor-based entertainment appliances, peer devices or other common network nodes, and typically include many or all of the elements described relative to the computer 1202. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1202 connects to the network via a wired/wireless communication subsystem 1242 (e.g., a network interface adapter, onboard transceiver subsystem, etc.) to communicate with wired/wireless networks, wired/wireless printers, wired/wireless input devices 1244, and so on. The computer 1202 can include a modem or other means for establishing communications over the network. In a networked environment, programs and data relative to the computer 1202 can be stored in the remote memory/storage device, as is associated with a distributed system. It will be appreciated that the network connections shown are exemplary and other means of establishing a communications link between the computers can be used.

The computer 1202 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a drawing component configured to draw a label as a 3D (three-dimensional) label object in a 3D scene and according to a label orientation;
a hierarchy component configured to input logical hierarchical information to the drawing component to draw the 3D label object in the 3D scene according to a logical hierarchy; and
at least one hardware processor configured to execute computer-executable instructions in a memory associated with the drawing component and the hierarchy component.

2. The system of claim 1, wherein the logical hierarchical information indicates label size of the label object relative to other label objects.

3. The system of claim 1, wherein the 3D label object is drawn to follow a contour of an associated scene object identified with the label object.

4. The system of claim 1, wherein the label orientation of the label object is maintained in response to manipulation of the 3D scene.

5. The system of claim 1, wherein the label object is drawn as oriented vertically on an associated line of a map.

6. The system of claim 1, wherein the label object is re-oriented to a new readable orientation in response to a predetermined delay following a manipulation of the scene.

7. The system of claim 1, wherein the labels are projected in a view plane of the 3D scene.

8. The system of claim 1, wherein the 3D label objects are drawn in the 3D scene based on properties of at least size, elevation, and orientation.

9. A method, comprising acts of:
receiving a multi-dimensional scene having scene objects represented as 3D scene objects;
assigning and presenting labels in association with the 3D scene objects as 3D label objects, the 3D label objects characterized in the scene with at least one of size, elevation, or orientation; and
configuring at least one hardware processor to execute instructions in a memory related to the acts of receiving and assigning.

10. The method of claim 9, further comprising representing size of a 3D label object as different from another label size according to a label hierarchy.

11. The method of claim 9, further comprising drawing a 3D label object in alignment with a contour in the scene, which is a 3D scene.

12. The method of claim 9, further comprising maintaining orientation of a 3D label object in response to a change of the scene.

13. The method of claim 9, further comprising projecting the labels in a view plane of the scene.

14. The method of claim 9, further comprising representing the 3D labels according to graphical emphasis that indicates a logical hierarchy.

15. The method of claim 9, further comprising, in response to a zoom-in operation of the scene from a given elevation and elevated 3D label object, phasing out the elevated 3D label object from view and drawing a new 3D label object associated with a lower elevation.

16. A computer-readable storage medium comprising computer-executable instructions that when executed by a hardware processor, cause the processor to perform acts of:
receiving a 3D scene having 3D scene objects; and
drawing labels into 3D scene as 3D label objects in association with one or more scene objects, the 3D label objects drawn according to a logical hierarchy characterized by label size, label elevation, and label orientation.

17. The computer-readable storage medium of claim 16, further comprising representing size of a 3D label relative to distance of the 3D label object from a virtual camera.

18. The computer-readable storage medium of claim 16, further comprising drawing a 3D label object in alignment with a contour in the 3D scene and in a readable orientation to a virtual camera from which the 3D scene is viewed.

19. The computer-readable storage medium of claim 16, further comprising re-orienting the 3D label objects to an orientation that ranges between a vertical orientation and a horizontal orientation, the 3D label objects re-oriented according to a stepped movement and relative to an acquiescence state.

20. The computer-readable storage medium of claim 16, further comprising drawing 3D label objects in association with curved 3D scene objects and with curvature that corresponds to curvature of the curved 3D scene objects.
